(19) United States
(12) Patent Application Publication
(10) Pub. No.: US 2024/0253272 A1
(43) Pub. Date: Aug. 1, 2024

(54) SYSTEM FOR ANALYZING MATERIAL SYSTEMS

(71) Applicant: HTE GMBH THE HIGH THROUGHPUT EXPERIMENTATION COMPANY, Heidelberg (DE)

(72) Inventors: Andreas Mueller, Heidelberg (DE); Simon Zelewski, Heidelberg (DE); Peter Kolb, Heidelberg (DE); Max Christoph Schmid, Heidelberg (DE); Daniel Ruffani, Heidelberg (DE)

(21) Appl. No.: 18/268,415

(22) PCT Filed: Dec. 16, 2021
(86) PCT No.: PCT/EP2021/086128

§ 371 Date: Jun. 20, 2023

(30) Foreign Application Priority Data
Dec. 21, 2020 (EP) 20216007.3

(51) Int. Cl. B29B 7/74; B01D 19/00; B01F 27/091; B01F 27/112; B01F 101/00; B01J 19/00; B29B 7/60; B29B 7/72; B29B 7/82; B29B 7/84; B29B 9/16; B29K 105/00

(52) U.S. Cl. CPC B29B 7/748; B01D 19/0036; B01F 27/091; B01F 27/112; B01J 19/0066; B29B 7/603; B29B 7/72; B29B 7/7461; B29B 7/823; B29B 7/826; B29B 7/845; B29B 9/16; B01F 2101/2204; B29B 2009/168; B29K 2105/0094

(57) ABSTRACT

The invention relates to a system for analyzing material systems by which a product is achieved which is highly viscous or solid at ambient conditions, the system (1) comprising a processing unit (3) for processing the viscous medium and at least one feeding device (7; 9) for feeding starting materials into the processing unit (3), the feeding device (7; 9) being established such that the amount of the starting material or the starting material can be varied, and the processing unit (3) further comprises an outlet (13) which is connected to a device (15) for producing pellets or test specimens if the product is solid at ambient conditions or to a dosing pump for transferring the product into a collecting vessel if the product is highly viscous at ambient conditions

The invention relates to a system for analyzing material systems by which a solid product is achieved from a viscous medium and which is operated in a high-throughput method for screening a large variety of catalysts and their influence on the medium properties.

Such material systems for example are reaction systems for producing polymers. Usually, polymers are produced by chemical reaction of monomers and/or oligomers. Further, depending on the kind of polymer, the material system may comprise additives. For analyzing the material system, particularly for searching a material system which has desired properties, it is necessary to vary the amounts of monomers and/or additives and further also the type of monomers and/or additives used. For this testing, a large number of experiments is necessary.

It is known from industrial processes for producing polymers to feed the monomers into a stirred vessel in which the reactants form the polymer. According to DE-A 195 04 671 a prepolymer is produced in the stirred vessel and then the prepolymer is fed into an extruder using a gear type pump. In the extruder, the reaction is completed and the thus produced polymer is formed into threads by pressing the polymer through a mold. A reactor system comprising an oligomerization reactor and a preheater which is followed by a flash tank is described in U.S. Pat. No. 7,632,931. In this system in the flash tank, the polymer is separated from a byproduct.

An apparatus for devolatilization is known from U.S. Pat. No. 6,211,331. The apparatus comprises a static mixer and a flash tank which holds a pressure below atmospheric pressure. For devolatilization, the polymer is fed through the static mixer into the flash tank. From the flash tank, the polymer is withdrawn through outlet chambers in which gear pumps are mounted.

A system for producing combinatorial libraries of materials is described in WO-A 02/081079. The system comprises a plug flow reactor into which one or more components are introduced. By changing over time at least one variable affecting the one or more components, a combinatorial library of materials is produced. The variables for example are concentration of starting material, type of starting material, pressure in the reactor, and temperature profile in the reactor.

By using a plug flow reactor and changing the variables during operation it cannot be excluded that there is a smooth transition between the separate experiments and that there might be remainders from a previous experiment which poisons a following experiment resulting in wrong results. Further, a plug flow reactor and a tank reactor have different residence time characteristics. Therefore, using a plug flow reactor in a system for analyzing reactions which usually are carried out in a tank reactor may lead to wrong results. Further, the maximum reaction time in a plug flow reactor is limited by the length of the reactor and the flow velocity whereas the reaction time in a tank reactor is not limited.

A further system for processing a liquid which allows for carrying out a large number of experiments is disclosed in WO-A 2020/225110. The system, disclosed in this document, comprises a holding device with a supply unit through which vessels can be easily changed.

It is an object of the present invention to provide a system for analyzing material systems by which a solid product is achieved from a viscous medium which allows for carrying out a large number of experiments with small effort.

This object is achieved by a system for analyzing a large number of material systems in small amounts by which a product is achieved which is highly viscous or solid at ambient conditions, the system comprising a processing unit for processing the viscous medium and at least one feeding device for feeding starting materials into the processing unit, the feeding device being established such that the amount of the starting material or the starting material can be varied, and the processing unit further comprises an outlet which is connected to a device for producing pellets or test specimens if the product is solid at ambient conditions or to a dosing pump for transferring the product into a collecting vessel if the product is highly viscous at ambient conditions.

In the context of the present invention, ambient conditions mean ambient temperature and ambient pressure. Usually ambient temperature denotes a temperature of 20° C. and ambient pressure a pressure of 1013 mbar.

“Highly viscous” in the context of the present invention means a viscosity which is above 10¹ mPas, more preferred in a range between 10³ mPas and 10¹⁰ mPas and particularly in a range between 10³ mPas and 10⁶ mPas. Viscosity values of viscous liquids will conventionally be measured by Rheometers. Viscosity of polymers will in practice better be expressed by the so-called melt flow index (MFI). These values range from 0.1 to 40 and indicate the mass of polymer loaded with weight of e.g. 2.16 kg pressed through a defined orifice in 10 minutes at 190° C. melt temperature. However, the above viscosity ranges will be exceeded in the process of solidification when exiting out of the reactor or separator. Further, viscosity of linear polymers, e.g. polyethylene glycol (PEG), is dominated by molecular mass. PEG 6000 e.g. ranges from 1 to 10⁶ mPas when solved in water up to 20 weight percent at 30 C.

“Small amounts” in the context of the present invention means an amount in a range from 0.001 to 1 kg, more preferred in a range from 1 to 100 g and particularly in a range from 1 to 10 g.

The inventive system for analyzing material systems particularly allows for a high degree of flexibility when combined with a conventional large-scale production technology like pellet or polymer strand sample extrusion. Such a flexibility is not possible by using a standard lab-scale tank reactor and pellet or polymer strand samples usually cannot be formed by known processes for analyzing catalysts due to the small sample sizes which usually are used in catalyst screening and which are typically in the range of only a few grams. Particularly when testing new catalysts which only can be synthesized efficiently in tiny amounts, these are not capable for a long-time continuous production.

In the present invention, the term “analyzing materials” does not primarily relate to the analysis of polymer melt during the reaction process but particularly on the analysis of the influence of catalysts and monomers or their composition ratio in the reaction.

The processing unit may comprise a processing vessel for carrying out batch processes or, as an alternative, a reactor, for example a plug flow reactor having a side outlet for sample drawing, a recirculated plug flow reactor, a loop reactor or a loop-type reactor. Independently of the kind of reactor, the reactor may comprise an integrated static or dynamic mixer. If the processing unit comprises a processing vessel, the processing vessel can be a batch reactor or a continuous stirred tank reactor.

Using a system with a processing vessel has the advantage that batch processes can be represented in an easy way. Further, it is possible to feed starting materials for the reaction in a defined way. This also allows for feeding one or more components at a defined time after the reaction started which is not possible by using a plug flow reactor as known from the art.

A further advantage of using a processing vessel, a loop reactor or a loop-type reactor as processing unit is that it is possible to measure data during the process which is carried out in the processing unit, for example a chemical reaction. Measuring data during the reaction further allows for analyzing the progress of the reaction. Data which can be measured during the process for example are pressure and temperature in the processing unit.

If the system is used for analyzing material systems by which a solid product is achieved, it is possible by connecting the outlet of the processing unit to a device for producing pellets or test specimens to produce the pellets or test specimens without an additional process step in which the solid product is melted again and then the test specimen are produced. Particularly for producing test specimens by injection molding or pellets by extruding a sufficient large amount of material is necessary due to the size of the apparatus used in the producing process. Therefore, if it is possible to directly produce the test specimen without such an additional step, a smaller amount of material is sufficient and the processing unit can be designed in a size which is typical for testing units and the amount solid product produced in the processing unit is sufficient for producing the test specimens.

If the system is used for analyzing material systems by which a highly viscous product is achieved, connecting the outlet with a dosing pump for transferring the product into a collecting vessel has the advantage that the whole product can be removed from the processing unit and that no or only very small amounts of product remain in the processing unit and/or the lines connecting the outlet of the processing unit with the dosing pump and the line connecting the dosing pump with the collecting vessel and in the dosing pump.

Particularly if the product produced in the processing unit may contain gaseous components or components which evaporate at reduced pressure, it may be necessary to remove these components. For removing the gaseous components or the components which evaporate at reduced pressure, it is particularly preferred to arrange a separation unit for degassing between the processing unit and the device for producing pellets or test specimens or the dosing pump for transferring the product into a collecting vessel. If such a separation unit for degassing is provided, after finishing the processing in the processing unit, the product is transferred into the separation unit for degassing.

The separation unit for degassing for example is a flash tank. For degassing, the product which is withdrawn from the processing unit is expanded. By this expansion, components which evaporate at reduced temperature evaporate and thereby form gaseous components. In the flash tank or vessel of the separation unit, the gaseous components are separated from the product and can be removed.

For expanding the product, it is particularly preferred to set a pressure in the flash tank which is below the pressure of the processing unit. For this purpose, it is particularly preferred to use a degassing vessel as flash tank. For evacuating the degassing vessel to obtain a pressure below the pressure in the processing unit, a vacuum pump is connected to the degassing vessel. Due to the pressure in the degassing vessel which is below the pressure in the processing unit, gas is removed from the product.

The pressure which is set in the degassing vessel depends on whether the product only contains gaseous components or if additionally components are contained which evaporate. In the latter case, the pressure is set such that the components which shall be removed from the product evaporate at the temperature in the degassing vessel.

If the crude product which is transferred from the processing unit to the separation unit for degassing has a low viscosity at the temperature at which the crude product is transferred into the separation unit for degassing and the degassing is carried out, the separation unit for degassing may comprise surface enhancing inserts like packings, for example Raschig rings, Lessing rings, Pall rings or saddles.

Such surface enhancing inserts also may be filled into the processing unit, if the crude product has a low viscosity at the processing temperature.

To avoid evacuation of the processing unit by pressure compensation, it is further preferred to provide a valve or a throttle in the connecting line between the processing unit and the unit for degassing. The valve or throttle may be placed at each position in the connecting line, however, it is particularly preferred, if the outlet of the valve or throttle is connected directly to the inlet of the degassing vessel.

If the separation unit for degassing comprises a vacuum pump, it is particularly preferred that the evaporated or gaseous components which are removed from the product are withdrawn by the vacuum pump. If the system comprises evaporated or gaseous components which may be harmful to the environment, the outlet of the vacuum pump may be connected to a gas purification unit. Alternatively, the gases may be collected in a suitable gas container and then transferred to a gas purification plant or, if the gases are combustible, to a flare.

If the product is solid at ambient conditions, the product outlet of the separation unit for degassing is connected to the device for producing pellets or test specimens. Correspondingly, the outlet of the separation unit for degassing is connected to the dosing pump for transferring the product into a collecting vessel if the product is highly viscous at ambient conditions.

If the system for analyzing material systems comprises a device for producing pellets or test specimens, the device for producing pellets or test specimens comprises a dosing unit and a mold, independently of whether the device for producing pellets or test specimens is connected to the processing unit or to the separation unit for degassing.

If a device for producing pellets is used, the mold comprises orifices through which the product is pressed and then cut into pellets. For this purpose usually a rotating knife may be used which runs on the surface of the mold. The pellets then are collected whereby for analyzing, it is important that the pellets made of each experiment are collected separately.

If a device for producing test specimens is used, a mold is used which corresponds to molds as usually used for producing molded parts. Such a mold usually comprises as least two parts which are connected and form a space in between which has the negative form of the component to be produced. Test specimens which may be produced, for example are tension rods, ribbon type specimen as described for example in DIN EN ISO 527-1, DIN EN ISO 527-2, DIN EN ISO 3167 (2014 November), or film specimen as described for example in DIN EN ISO 527, wherein the ribbon type specimen and film specimen are particularly preferred. These types of test specimen have the advantage that they do not require any additional final shaping after extrusion which slows down the test procedure. If different tests shall be carried out, it is possible to design the mold in such a way, that different test specimens are produced simultaneously by injecting the product into the mold. As usual for injection molding, in this case the mold comprises several injection channels which branch off a central inlet opening and through which the product is injected into the molds for the test specimens. Besides using a mold for producing different test specimens simultaneously, it is also possible to use different molds and to change the mold after the product is injected into one mold so that immediately after change of the mold the next test specimen can be produced.

For feeding the product into the mold if test specimens are produced or through the orifices of the mold if pellets are used, a dosing unit is used. By the dosing unit the pressure is generated which is necessary for forming either the pellets or the test specimens.

A suitable dosing unit for example is a dosing pump like a gear type pump, a piston pump, particularly a rotary piston pump, or a vane pump. As an alternative to a dosing pump, the dosing unit also may be screw injection machine. Such a screw injection machine for example is an extruder or an injection molding machine. Thereby, an extruder particularly is used if pellets are produced and an injection molding machine particularly for producing test specimens.

To intimately mix the components in the processing unit or to support degassing of the product in the degassing vessel, it is particularly preferred if the processing vessel and/or the degassing vessel comprise an axial conveying means.

A major rheological obstacle in small-scale laboratory reactors results from the different surface/volume ratio between internal walls and internal medium volume, which the processed medium experiences compared to large-scale production reactors. This larger ratio disables a free flow of polymer from the scraper when rubbing with the scraper against the plain reactor vessel walls. This is due to an increasing influence of surface driven adherence forces between melt and walls when the ratio is large. In large reactors, shear forces between the internal melt and the melt on the scraper are large enough to remove the melt on the scraper after some time. However, this is not the case in small size reactors.

Another aspect are the large inertia forces of the larger mass of the bulk melt in large reactors, which allows for shear force development between rotating blades and inert bulk mass. Additionally in large reactors the blade rotational speed close to the wall can be large enough for removing the blade coating because the rotational speed increases with the radius of the reactor at constant angle velocity. In order to compensate this size effect and increase the shear forces to a reasonable level for cleaning the blades, one would have to increase the rotary speed of a small-scale scraping stirrer to a level which would lead to an increase in melt temperature due to the introduced stirrer energy and thus a polymer melt overheating and degradation without even addressing the additional inertia problem. All these aspects introduce the effect of melt remaining on the blades after scraping and its accumulation there. This fact gets particularly painful when very small amounts of melt are produced in a series of experiments with a variety of precious catalysts which cannot easily be synthesized again when a trial fails. Typical sample sizes produced are in the range of grams and not kilograms or even tons. Very easily a major amount of the sample gets caught on the scraper blades and also gets thus back-mixed with new sample trials with new catalysts. One solution to overcome such a sample loss is a conveying means which does not accumulate polymer melt on itself. This can be realized for example by using vessel dimensions which are more like tubular vessels with a tube length at least three times the tube diameter. Another helpful means is using the axial conveying means as a scraper and the particular design including drive of the axial conveying means. The scraper task here primarily is an axial movement of the melt along the tube. This can either be realized by using an axial conveying means having a rotating screw-type design with a primary axial movement and only secondary rotational melt movement but also by an axial conveying means having a more piston-like design. In the latter design the conveying direction is only axial. A non-rotating piston with a rotating drive can be realized. In this case the drive works similar to a screw gear which only moves the piston axially and not rotationally. All these designs enable to modify a standard autoclave vessel with a rotating drive for such conveying means. However, also a non-rotating drive can be applied. The similarity among all these designs is their reduced capability of agglomerating polymer on their surface due to their low surface area compared to a standard wall scraper. In a further preferred variation, the design of the conveying means being in contact with the melt has a cone-like shape avoiding any melt-filled dead spaces close to the entry into the gear pump in such a way that at the extreme extended position all the melt gets conveyed to the pump without residues. One should note that such a conveying means does not produce a lot of pressure for conveying. Instead it only cleans the walls after or even during the reaction in the vessel by e.g. repeated extension via the drive along the pipe-like vessel. Such a conveying means must nevertheless be equipped with a seal-like means as well. The screw conveys basically by rotation, thus it must be equipped with a flexible wiping means with seal-like characteristics. The screw may be a closed screw which means that opposite to the lower surface which is in contact with the melt, the upper surface is closed with a seal towards the melt in order to avoid melt bypassing the screw. In case of a piston-like scraper the conveying direction is basically axial and thus requiring a flexible piston-type seal. The conveying pressure necessary for producing strands or pellets downstream of the reactor is executed by the gear pump only. By choosing such a function split between scraping function and melt pressurization function conventional seals can be found which can be operated under process temperature, thereby experiencing only a mild pressure difference between the melt touching surface and the surface opposite to the melt, and are also robust against monomers, solvents and aggressive catalysts.

The product quality of the melt is not affected when the degassing process of the polymer melt will be disturbed by a regular but seldom intermediate cleaning using the axial conveying means, which introduces a short batch period to an otherwise continuous process. That temporary slight increase of pressure, which occurs when the axial conveying means is activated, does not influence the product properties compared to constant pressure operation without intermediate cleaning. However, the cleaning period must be limited to a fraction of less than 10% of the overall process residence time of the melt solution which is piped either to the flashing vessel or degassed inside the reactor directly. Also the over-pressure introduced to the degassing process must be as small as possible. Considering this, a rotating and sealed screw introduces of course a lower pressure increase compared to an axial conveying means which only moves axially towards the melt. Even closing the inlet or exit valves to the flasher for the period in which wall scraping is operated can thus not affect the residual solvent in the solid granules strongly. It is assumed that the degassing mass exchange gets balanced during the remaining continuous operation.

If the axial conveying means is either a closed-screw type or a piston-type scraper, the axial conveying means can be equipped with an internal valve for releasing the gaseous solvent during degassing. During axial movement of the axial conveying means, this valve is closed before it reaches the melt basin. When using a piston, as an alternative to such an internal valve also a simple radial exit boring in the flasher can be foreseen, which is opened as soon as the piston reaches its upper limit position.

Particularly if the system comprises a processing vessel and is used for analyzing material systems which tend to form fouling on the walls of the processing vessel and/or the degassing vessel, it is particularly preferred if the stirrer is a horseshoe mixer. For scraping material which adheres to the walls of the processing vessel and/or the degassing vessel, it is particularly preferred, if the horseshoe mixer comprises at least one stirrer blade which is designed such that solid material which deposits on the walls of the processing vessel and/or the degassing vessel is scraped off the walls by the stirrer blade. For scraping off deposits on the walls, the stirrer blade scrapes along the interior wall of the processing vessel and/or the degassing vessel.

If deposits are formed only in the processing vessel, it is sufficient to design the stirrer of the processing vessel in such a way that at least one blade scrapes along the interior wall of the processing vessel. The stirrer of the degassing vessel in this case may be any suitable stirrer. Accordingly, if deposits are formed only in the degassing vessel, it is sufficient to design the stirrer of the degassing vessel in such a way that at least on blade scrapes along the interior wall of the degassing vessel and the stirrer of processing vessel may be any suitable type of stirrer. However, usually, if material systems are analyzed which form deposits in one vessel, they also tend to form deposits in the other vessel. Therefore, if the system comprises a processing vessel and a degassing vessel, it is particularly preferred to provide both vessels, the processing vessel and the degassing vessel, with a stirrer which has at least one blade by which deposits are scraped off the wall of the respective vessel.

If the material system forms deposits which cannot easily be removed or if residues of the material system remain in the processing vessel after the product was removed from the vessel which cannot easily be removed, for example by cleaning the vessel, it is preferred that the processing unit comprises a vessel holder for changing the processing vessel. The vessel holder may be designed for example as described in WO-A 2020/225110. To achieve only short breaks between two experiments, it is preferred that the feeding device and the outlet are connected to the vessel holder. The connection of the feeding device and the outlet to the vessel holder has the additional advantage that the vessel can easily be changed and it is not necessary to connect the feeding device and the outlet to the vessel after changing.

If the processing vessel can be changed, it is possible to take samples by first removing the processing vessel from the processing unit and then connect the processing vessel to an outlet line via which the crude product is withdrawn from the processing vessel. In this case the outlet line is at a different position to the position of the processing vessel during carrying out the process. This has the advantage, that while withdrawing the crude product from the processing vessel, a new processing vessel can be placed in the processing unit for starting the next experiment.

If data are measured during each process which is carried out in the processing vessel, it is preferred to arrange the sensors which are used for measuring the data at a place where it is not necessary to remove the sensors when the vessel is changed. Therefore, it is particularly preferred to arrange the sensors close to the feeding device, for example in a cover which is connected to the system and remains in place while the processing vessels are changed. After changing the processing vessel, the processing vessel is closed with the cover and the process can start.

Alternatively, particularly if material systems are analyzed where no deposits are formed or deposits which can be removed in a short time, or a quick exchange of the processing vessel is not possible, like in systems comprising a loop reactor or a loop-type reactor as processing unit, it is preferred to provide a cleaning unit for cleaning the processing unit. The cleaning unit for example comprises an injection lance for spraying a cleaning liquid into the processing unit. The used cleaning liquid preferably is removed via the outlet of the processing unit. Alternatively, it is also possible to provide a second outlet for removing the cleaning liquid. If the cleaning liquid is removed via the outlet of the processing unit through which also the reaction product is removed, it is preferred to connect the outlet line with a collecting vessel for the used cleaning liquid to avoid cleaning liquid flowing into the environment. If a second outlet for removing the cleaning liquid is provided, it is preferred to connect the second outlet with a container for collecting the used cleaning liquid. From the container or the collecting vessel, the used cleaning liquid can be transferred to a work-up unit for working up the cleaning liquid. Alternatively, it is also possible to dispose the cleaning liquid. If the cleaning liquid is worked up, the worked-up cleaning liquid then can be used again for cleaning the processing unit.

If the cleaning unit comprises an injection lance, it is preferred that the injection lance comprises a nozzle at its end through which the cleaning liquid is sprayed. The pressure of the cleaning liquid when leaving the nozzle preferably is at least 5 bar, more preferred at least 100 bar and particularly at least 500 bar. If the material of the processing unit and the holding device is stainless steel, even a pressure of at least 1000 bar is preferred. By such a pressure, impurities adhering on the walls can be mechanically removed. The maximum pressure which can be used for cleaning depends on the material of the processing unit and the impurities to be removed. The maximum pressure is selected such that the processing unit is not damaged by the cleaning liquid.

If a system is used which comprises a processing unit and a degassing vessel, it is particularly preferred, to also provide a cleaning unit as described above in the degassing vessel for removing possible impurities from the walls of the degassing vessel.

If the processing unit and/or the degassing vessel can be cleaned and is/are not changed, it is possible to arrange sensors for measuring data at any place in the processing unit and/or the degassing vessel. Like for a system with changeable vessels, the sensors also can be arranged in a cover. Particularly for measuring the temperature in the material system it is possible to arrange temperature sensors at different positions in the processing unit and/or the degassing vessel. This allows for example for measuring whether there is a temperature difference in the system during the process.

If a cleaning unit is used for cleaning the processing unit and/or the degassing vessel, it is particularly preferred, to provide at least two processing units and/or degassing vessels. This allows for carrying out the process in one processing unit and/or degassing vessel while the other processing unit and/or degassing vessel is cleaned. By such an arrangement the number of experiments which can be carried out can be increased.

Further, it is preferred that the system comprises a temperature regulating element for tempering the processing unit and/or a temperature regulating element for tempering the degassing vessel, if a degassing vessel is comprised. Depending on the process to be carried out in the system, the temperature regulating element can be a heating element, a cooling element or a device which allows for heating and cooling. Such a temperature regulating element for example can be a heating or a cooling coil, a double jacket or an electrical heating element or induction heating. If a heating or cooling coil or a double jacket is used, for tempering the contents of the processing unit and/or the degassing vessel, preferably a tempering medium is used which flows through the heating or cooling coils or through the double jacket. The tempering medium for example can be water, oil, steam or a cooling liquid. If the temperature regulating element only is used for heating, it is particularly preferred to use an electrical heating element or induction heating. Besides using cooling coils or a double jacket through which a cooling liquid flows, it is also possible to use Peltier elements for cooling.

If the system comprises a processing unit and a degassing vessel, both, the processing unit and the degassing vessel can be equipped with the same type of temperature regulating element. However, depending on the process carried out in the system and the type of processing unit, it is also possible to equip the processing unit and the degassing vessel with different types of temperature regulating elements. If the processing unit and the degassing vessel shall be heated or cooled to different temperatures, it is possible to use different temperature regulating elements or, alternatively, to use the same type of temperature regulating elements at different temperatures or, if the temperature regulating elements comprise heating or cooling coils or a double jacket through which a tempering medium flows, to use the same tempering medium at different temperatures or different tempering media.

The components of the system, particularly the processing unit, the degassing vessel, stirrers and connecting lines can be made from any material which does not affect the process which is carried out in the system. Suitable materials for example are metals, plastics, ceramic, porcelain or glass. Metals which can be used for example are aluminum, steel, stainless steel or nickel-base alloys. If the material is a plastic, preferably polytetrafluorethylene (PTFE), polypropylene (PP) or polyethylene terephthalate (PET) are used. The different components of the system may be made from different materials or from the same material.

Besides producing the components from one material, it is also possible to provide the inner surfaces which come into contact with the material system with a coating. This allows for using an ordinary material for producing the body and another material for the coating, for example steel or aluminum for the body and stainless steel or a nickel-base alloy for the coating or a metal like steel or aluminum for the body and a ceramic like alumina or a plastic for the coating. To improve inertness of the material it is also possible to use a plastic for the body and a metal for the coating. If a component is equipped with a coating, the material for the coating is selected such that it does not affect the process which is carried out in the system. Suitable materials for the coating, therefore, preferably are the same as described above for the components being produced from only one material without a coating.

Material systems which can be analyzed by using the inventive system particularly are highly viscous systems. Analyzing these systems by using known equipment is time consuming and, therefore, the number of experiments is limited. By the inventive system where the outlet of the processing unit or the degassing vessel is connected to the device for producing pellets or test specimens or to the dosing pump for transferring the product into a collecting vessel, time for producing the test specimens or pellets or collecting the product can be reduced and, thus, the necessary time for carrying out one experiment including formation of test specimens can be reduced and the number of experiments can be increased.

Particularly preferably, the system is used for polymeric systems. For analyzing polymeric systems, reactants are fed into the processing unit. In the processing unit the reactants react, forming the polymer. Reactants fed into the processing unit comprise monomers for producing the polymer and optionally additives like surface-active substances, fillers, flame retardants, nucleating agents, dispersing agents, antioxidants, lubricants and catalysts, dyes and pigments, stabilizers, e.g. with respect to hydrolysis, light, heat or discoloration, reinforcing agents, and plasticizers. Such polymeric systems may be either polymeric systems where the monomers react in the melt or, alternatively, polymeric systems where the reaction is carried out in a solvent.

Particularly in the polymer research, it is necessary to carry out a large number of experiments with variations in the amount or ratio of monomers and, if present, solvent and of the additives, particularly catalyst, as well as in the time of addition of the respective components.

Polymers for which the inventive systems can be used are for example polymers which solidify after cooling like non-hardening polymers or adhesives or polymers which tend to cross-link and then are no longer flowable, like epoxy resins.

Further, polymers which solidify after cooling are for example polyesters, polyamides, polyacrylnitrile, polyvinylchloride or cellulosic fiber polymers or bio-based polymers in general which often tend to fouling during reaction. Bio-based polymers in this context means polymers which are made of natural or biological feedstocks, e.g. lignin, cellulose, glucose and starch.

The system further can be used for reinforced polymers, particularly such, in which the reinforcing agent is added as a powder or short fibers.

If the reaction is carried out in a solvent, the polymer is separated from the solvent after the reaction was terminated. Separation of the polymer from the solvent may take place in the separation unit for degassing. However, preferably, the polymer is separated from the solvent when being removed from the processing unit or in a separation unit which is connected downstream the processing unit, wherein the separation unit is arranged upstream the device for producing pellets or test specimens if the product is solid at ambient conditions or the dosing pump for transferring the product into a collecting vessel if the product is highly viscous at ambient conditions.

If a processing vessel is used in the system, for separating the solvent from the polymer it is possible to use a processing vessel having a porous bottom area. After terminating the reaction, a valve below the porous bottom is opened and the solvent flows through the porous bottom and can be withdrawn through a line which is opened by opening the valve. The polymer remains in the processing vessel.

If the separation of the solvent is carried out in separate separation unit, the separation unit preferably comprises a filter element. In the separation unit, the solvent is the permeate and can be collected, optionally worked-up and reused, and the polymer melt is the retentate and flows to the device for producing pellets or test specimens if the product is solid at ambient conditions or to the dosing pump for transferring the product into a collecting vessel if the product is highly viscous at ambient conditions.

For removing the solvent completely from the polymer, it is preferred to set a vacuum. If the solvent is separated off in the processing unit, a vacuum pump is connected to the processing unit and after terminating the reaction, the processing unit is evacuated. If a separate separation unit is used, the separation unit is connected to vacuum pump.

If the solvent or remaining monomers or other components comprised in the crude product are gaseous or evaporate at reduced pressure and the temperature of the crude product or the temperature to which the separation unit for degassing is tempered, it is also possible to omit the separation unit for removing the solvent and use only the separation unit for degassing to remove the solvent or remaining monomers.

To improve separating off the gaseous components or components which evaporate, it is particularly preferred to provide a venting valve which preferably is connected to an inert gas tank. By opening the venting valve for a short time, the pressure in the separation unit for degassing increases. By this pressure increase, gas bubbles, which form by outgassing of gaseous or evaporating components, collapse. When the valve is closed again, the gas bubbles will form again. This process will be repeated as often as needed. This sequence of collapsing and bursting of gas bubbles results in an increase of the mass exchange surface and an additional mixing of the polymer. The additional mass exchange surface and the additional mixing improves outgassing of components in those parts which have a larger distance from the surface.

Further, degassing can be improved by transport of the polymer from the bottom of a degassing vessel to the surface. This transport usually is obtained by using a mixing device like a stirrer. If the stirrer also acts as a part of a pump feeding process as described above one preferred way of operation is the reversal of the stirrer rotary direction during degassing.

Embodiments of the invention are shown in the figures and described in more detail in the following description.

In the figures:

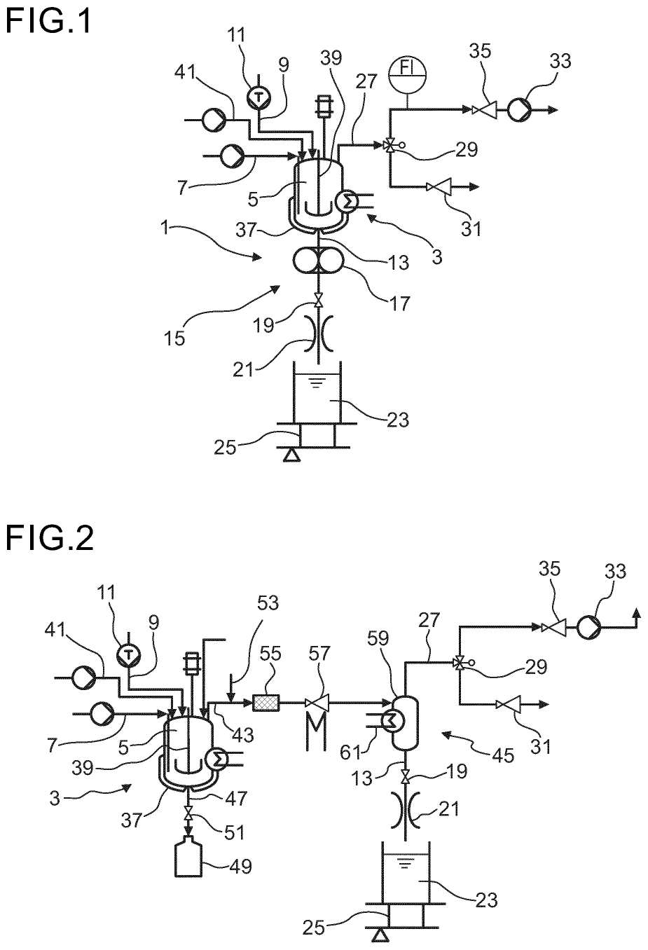

FIG. 1 shows an inventive system for analyzing material systems in a first embodiment,

FIG. 2 shows an inventive system for analyzing material systems with a separation unit for degassing,

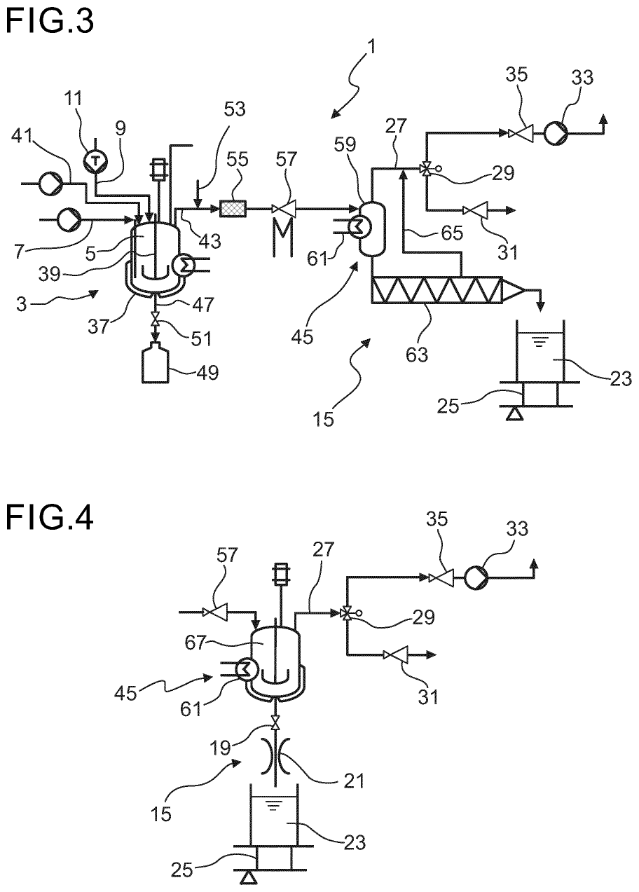

FIG. 3 shows an inventive system for analyzing material systems with a separation unit for degassing in a second embodiment,

FIG. 4 shows a separation unit for degassing and a device for producing pellets or test specimens,

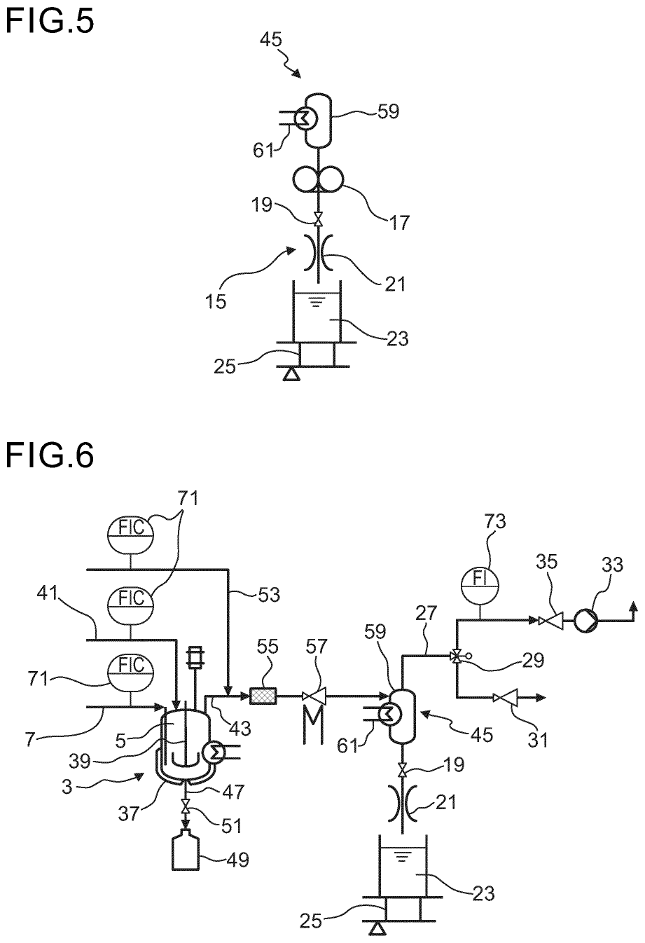

FIG. 5 shows a separation unit for degassing and a device for producing pellets or test specimens using a gear type pump,

FIG. 6 shows an inventive system for analyzing material systems with a separation unit for degassing with mass flow sensors,

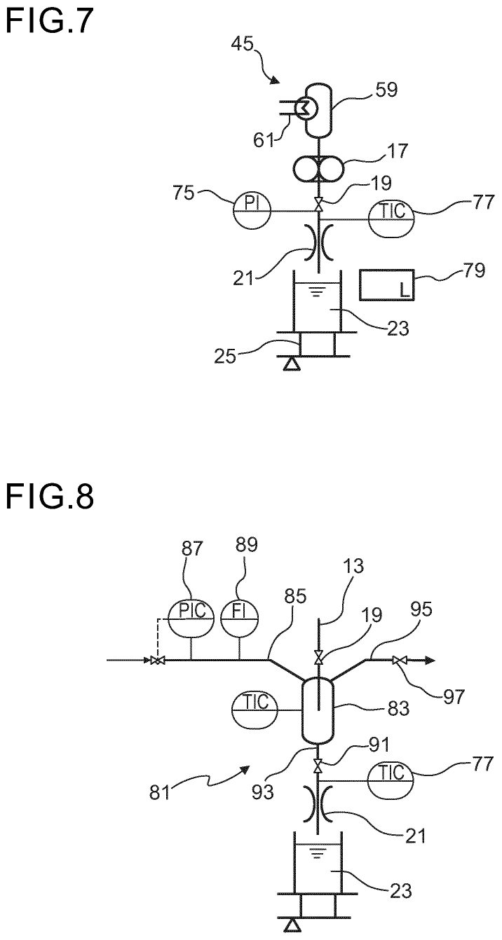

FIG. 7 shows a separation unit for degassing and a device for producing pellets or test specimens with sensors for measuring pressure and temperature,

FIG. 8 shows a unit for measuring the melt flow index which is connected to a device for producing pellets or test specimens with sensors for measuring pressure and temperature and a venting unit,

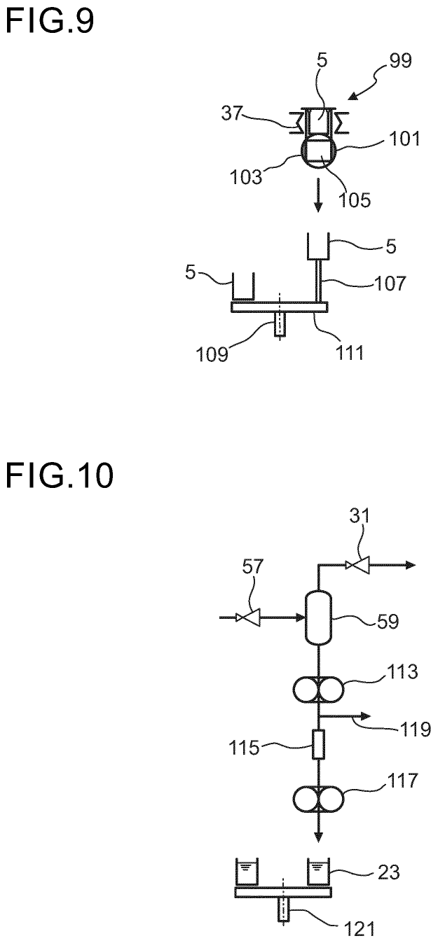

FIG. 9 shows a processing unit with changeable processing vessels,

FIG. 10 shows a unit for taking samples with a carousel changer.

FIG. 1 shows an inventive system for analyzing material systems in a first embodiment.

The system 1 comprises a processing unit 3 for processing starting materials, for example by carrying out a chemical reaction. The processing unit 3 as shown here comprises a processing vessel 5. For feeding starting material, a feed line 7 is connected to the processing vessel 5. For adding further starting materials or additives, a second feed line 9 is connected to the processing vessel. The second feed line 9 preferably comprises a pump 11 which allows for a defined dosing. By using such a pump, for example a reciprocating pump, a diaphragm pump or a gear type pump, it is possible to vary the amount of additives precisely in different experiments. By this, the influence of the additive on the product can be observed.

At the bottom of the processing vessel 5, a product outlet 13 is provided. Through the product outlet 13 the crude product which was produced in the processing vessel 5 is withdrawn. The product outlet 13 is connected to a device 15 for producing pellets or test specimens. The device for producing pellets or test specimens comprises a dosing unit 17, for example a gear type pump.

The dosing unit 17 is followed by an outlet valve 19 and a flow restrictor 21. The product produced in the processing vessel 5 is pressed through the outlet valve 19 and the flow restrictor 21 by using the dosing unit 17. By this arrangement, a strand is produced which can be cut into pellets or into test specimens. For cooling, the strand or the pellets is/are fed into a quenching bath 23. The quenching bath 23 preferably contains a cooling liquid, for example water, which has ambient temperature. The quenching bath 23 may be placed on scales 25 to measure the amount of product removed from the processing vessel 5.

Besides the product outlet 15, a gas outlet 27 is connected to the processing vessel 5. The gas outlet 27 enters into a pressure switch valve 29. The pressure switch valve 29 as shown here comprises a first outlet which is connected to a first back pressure regulator 31 and a second outlet which is connected to a vacuum pump 33. In the connecting line from the pressure switch valve 29 to the vacuum pump 33 a second back pressure regulator 35 is arranged.

If the process in the processing vessel 5 is carried out at ambient pressure or at a pressure above ambient pressure, the pressure switch valve 29 opens the connection from the processing vessel 5 to the first back pressure regulator 31 and closes the connection to the vacuum pump. By using the first back pressure regulator 31, the pressure in the processing vessel is adjusted.

If a process is carried out in the processing vessel 5 at a pressure below ambient pressure, the pressure switch valve 29 opens the connection from the processing vessel 5 to the vacuum pump 31 via the second back pressure regulator 35 and closes the connection to the first back pressure regulator 31. By using the second back pressure regulator 35, it is possible to precisely adjust the pressure in the processing vessel 5.

For analyzing the gas stream withdrawn from the processing vessel 5 via the gas outlet 27, it is possible, to provide analytical equipment in the gas line to the pressure switch valve 29 or in one or both gas lines being connected to the outlets of the pressure switch valve 29. Suitable analytical equipment for example comprise an apparatus for determining the composition of the gas stream, for determining the temperature or the pressure or combinations thereof.

For setting the temperature in the processing vessel, for example for carrying out processes at a temperature above or below ambient temperature or for keeping a constant temperature in the processing vessel 5 for example if processes are carried out which consume energy or release energy like endothermic reactions or exothermic reactions, it is preferred to provide the processing vessel 5 with a temperature control means 37. The temperature control means 37 for example comprise a double jacket or coils inside or outside the processing vessel 5, the double jacket or the coils being passed through by a suitable temperature control medium. Further, for heating, the temperature control means 37 may comprise electrical heating or induction heating, and, for cooling, the temperature control means 37 may comprise Peltier elements. However, particularly preferably, the temperature control means 37 comprise a double jacket or coils inside or outside the processing vessel 5.

Further, particularly if processes are carried out in the processing vessel 5, where the components in the processing vessel 5 must be mixed, a stirrer 39 is provided. The type of stirrer 39 used depends on the process to be carried out and is selected accordingly. If a process is carried out in the processing vessel 5 where components tend to form deposits on the walls of the processing vessel 5, it is particularly preferred to use a stirrer which has at least one blade which scratches the deposits from the wall. A suitable stirrer for example is a horseshoe mixer.

To clean the processing vessel 5 after an experiment is finished and the product is withdrawn from the processing vessel 5, a cleaning unit 41 is connected to the processing vessel 5. The cleaning unit preferably is connected to a feed line for a cleaning liquid which is fed into the processing vessel 5 for cleaning. To remove impurities, the cleaning liquid preferably is injected into the processing vessel with a high pressure, preferably through a rotating nozzle. Further, to reach all interior walls of the processing vessel, the cleaning unit 41 may comprise a lance with a nozzle at the end. The cleaning liquid is injected through the nozzle and by using the lance, it is possible to move the nozzle in such a way that cleaning liquid can be sprayed to each position in the processing vessel 5. The lance thereby may be controlled by a suitable control device, for example a robotic arm.

FIG. 2 shows an inventive system for analyzing material systems with a separation unit for degassing.

In difference to the system 1 shown in FIG. 1, in the system 1 shown in FIG. 2, a first outlet 43 of the processing vessel 5 is connected to a separation unit 45 for degassing. A second outlet 47 of the processing vessel 5 is connected to a waste container 49. In a connection line from the second outlet 47 to the waste container 49, an outlet valve 51 is arranged. By the outlet valve 51, the connection line from the second outlet 47 to the waste container 49 can be closed. The second outlet 47 for example can be used to drain solvent or non-reacted monomers after termination of the process carried out in the processing vessel 5. For draining the solvent or non-reacted monomers, the outlet valve 51 is opened and the solvent or non-reacted monomers can flow out of the processing vessel 5. To retain the product in the processing vessel, it is preferred to provide a filter element in the outlet or at the bottom of the processing vessel, wherein the filter element is selected such that the solvent or non-reacted monomers can pass and the product remains in the processing vessel 5.

Additionally or alternatively, the second outlet 47 also may be used for withdrawing cleaning liquid from the processing vessel 5 during a cleaning step. For withdrawing the cleaning liquid, it is possible to either keep the outlet valve 51 open during the whole cleaning process or to add cleaning liquid through the cleaning unit 41 into the processing vessel and to open the outlet valve 51 after finishing the cleaning or between two cleaning steps.

The cleaning unit 41 preferably is designed in the same way as described above for the embodiment shown in FIG. 1.

The product is removed from the processing vessel 5 via the first outlet 43. For cooling the product, a reaction quench 53 may be arranged in the connecting line from the first outlet 43 to the separation unit for degassing 45. Further, a mixer 55, preferably a static mixer, may also be arranged in the connecting line from the first outlet 43 to the separation unit for degassing 45. The static mixer will be preferably manufactured using additive manufacturing. This technology allows a design in which tube and mixing elements will be manufactured as one piece allowing an intensive heat transfer in the crude product by mixing and through the tube wall being in contact with a tempering device. The crude product passes then through the pressure reducer. The temperature drop and premature cooling of the melt because of gas expansion during throttling in the pressure reducer can thus be compensated. Independently of whether a reaction quench 53 and a mixer 55 is arranged in the connecting line, the connecting line comprises a third back pressure regulator 57, which may additionally be heated. By the third back pressure regulator 57, the pressure in the processing vessel 5 is kept and the product which is transferred from the processing vessel 5 into a flash tank 59 of the separation unit for degassing 45 is expanded in the third back pressure regulator 57.

For degassing the product, the flash tank 59 is evacuated and thus, the product being fed into the flash tank 59 is expanded and gas bubbles which have formed in the product burst and the gaseous components can be withdrawn via the gas outlet 27. The gas outlet 27 preferably is connected to the pressure switch valve 29 which has two outlets, one being connected to the first back pressure regulator 31 and the second to the second back pressure regulator 35 and the vacuum pump 33. The design of the gas outlet and the components being connected to the gas outlet 27 thereby preferably corresponds to that as shown in FIG. 1 for the gas outlet of the processing vessel 5.

The flash tank 59 may comprise a tempering unit 61 for heating or cooling. The tempering unit 61 may comprise, for example, a double jacket or tempering coils through which a tempering medium flows. If it is intended to evaporate components, it is for example possible to heat the product in the flash tank 59. On the other hand, if the temperature of the product is too high, the product can be cooled in the flash tank. A too high temperature may, for example, destruct the product or even product may evaporate at the low pressure in the flash tank 59. Besides heating or cooling the product, the tempering unit 61 also can be used to keep the temperature constant in the flash tank 59.

For withdrawing the product from the flash tank 59, the flash tank 59 comprises the product outlet 13 which is connected to the device 15 for producing pellets or test specimens.

FIG. 3 shows an inventive system for analyzing material systems with a separation unit for degassing in a second embodiment.

The system 1 for analyzing material systems shown in FIG. 3 differs from the system 1 shown in FIG. 2 in the type of the device 15 for producing pellets or test specimens. The device 15 for producing pellets or test specimens shown in FIG. 3 comprises a screw injection machine 63 as dosing unit. The screw injection machine 63 may be an extruder for producing continuous strands or pellets or an injection molding machine for producing separate test specimens.

The screw injection machine may be operated under vacuum. If this is intended, a gas outlet 65 of the screw injection machine is connected to the gas outlet 27 of the flash tank 59. If the product which is formed to strands or test specimens by using the screw injection machine 63 still contains gaseous impurities, the gas outlet 65 also may be used for additional degassing of the product. Producing strands, pellets or test specimens by using the screw injection machine 63 corresponds to the usual processes known to the skilled person.

In FIG. 4, a separation unit for degassing and a device for producing pellets or test specimens is shown in more detail.

The device 15 for producing pellets or test specimens corresponds to that as shown in FIG. 2. In difference to the separation unit for degassing 45 which is shown in FIG. 2, the separation unit for degassing 45 shown in FIG. 4 comprises a degassing vessel 67 instead of the flash tank 59.

For supporting the degassing process and particularly for bringing gas bubbles to the surface of the product so that also gas which is contained at positions away from the surface can be removed, it is preferred that the degassing vessel 67 is equipped with a stirrer 69. The stirrer may be of the same type as described above for the stirrer 39 of the processing vessel 5.

FIG. 5 shows a separation unit for degassing 45 and a device 15 for producing pellets or test specimens using a gear type pump.

In difference to the device 15 for producing pellets or test specimens being connected to the separation unit for degassing 45 as shown in FIGS. 2 and 4, the device 15 for producing pellets or test specimens shown in FIG. 5 additionally comprises a dosing unit 17. The dosing unit 17 preferably is a gear type pump and the function of the device 15 for producing pellets or test specimens corresponds to that as described above for the embodiment shown in FIG. 1.

The device 15 for producing pellets or test specimens shown in FIG. 5 may replace the device for producing pellets or test specimens shown in FIG. 2 or 4.

An inventive system for analyzing material systems with a separation unit for degassing with mass sensors is shown in FIG. 6.

The system 1 for analyzing material systems with processing unit 3 and separation unit for degassing which is shown in FIG. 6 corresponds to that which is shown in FIG. 2. In difference to the system shown in FIG. 2, here additionally mass sensors for determining and/or controlling mass flows are comprised.

The feed line 7 and the second feed line 9 preferably are equipped with a flow control 71. This flow control 71 allows for an exact dosage of the starting materials fed into the processing unit. An exact dosage particularly is necessary, if it is intended to analyze the influence of variations in the amounts of starting materials or additives used in the process.

The material being removed from the process can be determined by a flow sensor 73. Further, the amount of product obtained in the process can be determined by using the scales 25. If a system 1 is used with a waste container 49, it is possible to also weigh the amount of waste collected in the waste container. By determining these values and, optionally, the composition of the different material streams, it is for example possible to determine the selectivity, the conversion rate and the yield of the process.

FIG. 7 shows a separation unit for degassing and a device for producing pellets or test specimens with sensors for measuring pressure and temperature.

The separation unit for degassing 45 shown in FIG. 7 corresponds to that as shown in FIG. 5. In difference to the separation unit for degassing 45 shown in FIG. 5, here additionally a pressure indicator 75 for measuring the pressure and a temperature control 77 are comprised. By using the pressure indicator 75, the pressure is determined which is produced by the dosing unit 17. The value determined by the pressure indicator 75 can be used for example for controlling the dosing unit 17. For achieving comparable products, particularly test specimens, it is further necessary that the test specimens are produced under comparable conditions. For this purpose, the device 15 for producing pellets or test specimens additionally is equipped with the temperature control 77. The temperature control 77 allows for controlling the temperature in the device for producing pellets or test specimens in such a way that test specimen of one experiment or of different experiments are produced under the same conditions.

Further, for determining the density of the product, a level measurement 79 can be provided. By measuring the mass of the quenching bath 23 and the fill level in the quenching bath 23 by using the level measurement 79, the density and the volume flow of the product can be determined.

Further, selecting the pressure p between pump and restriction 21 by adjusting the pumps' rotational speed appropriately and choosing a flow restriction 21 having a cross-sectional area A, further keeping the temperature T constant and determining the volume flow downstream of the restriction, a relative viscosity measure similar to the melt flow index (MFI) can be obtained by adjusting the pressure p according to the following simple formula derived from a balance of forces between melt surface in the tank and viscous friction in the narrow cross-section of the restriction expressed by the pressure p:

$$p = \frac{F}{A} = \frac{m \cdot g}{A} .$$

In this formula m is the mass of a calibrated weight being used for loading the viscous liquid, g is the gravitational constant and A is the cross-sectional area of the restriction. If the viscous liquid is a polymer, the calibrated weight usually is 2.16 kg and the test usually is executed at 67.5 bar and a temperature of 190° C. However, other indices can also be selected by altering the inner diameter d=2r of the restriction and adjusting the pump pressure p according to the formula and keeping the melt temperature Tat the required value according to the specifications for the melt flow index.

This approach allows an inline measurement of an important melt characteristics which typically is offline detected. The such measured melt flow index can be used to adjust process parameters or additive dosing or change of monomer compositions according to these online results (so-called feedback loop).

The described procedure follows as close as possible the specifications for the melt flow index given in ASTM D1238 and ISO 1133 standards. When the obtained results get calibrated against these offline standards the inline measurements can be considered to be well comparable with the standardized offline measurements.

FIG. 8 shows a unit for measuring such a relative viscosity which is connected to a device for producing pellets or test specimens with sensors for measuring pressure and temperature and a venting unit.

A unit for measuring the relative viscosity 81 comprises a vessel 83 which is connected to the product outlet 13 of the separation unit for degassing 45. After filling the vessel 83 with a defined volume of product, the pressure in the vessel 83 is increased by feeding an inert gas into the vessel 83 through gas feed 85. For emptying the vessel 83 by applying a defined pressure, the gas feed 85 is equipped with a pressure control 87 and a flow sensor 89. The flow sensor shows the amount of gas which is fed into the vessel 83 and by the pressure control 87, the gas pressure is controlled.

After opening outlet valve 91, the product is pressed out of the vessel 83. For achieving comparable results, the temperature in the outlet 93 is controlled by using a temperature control 77. Further, as described above, a flow restriction 21 is provided in the outlet 93 for achieving a defined pressure loss. For determining the relative viscosity, additionally, the volume flow during emptying the vessel 83 is determined. This can be done as described above in connection with FIG. 7 by measuring the fill level in the quenching bath 23 and the mass of the quenching bath 23.

For withdrawing the gas from the vessel 83, a gas outlet 95 can be provided which can be closed by a valve 97.

If it is not possible to clean the processing vessel between two experiments, either for firmly bonded deposits or because the time for cleaning would be too long, it is preferred to design the processing unit 3 in such a way that the processing vessel 5 easily can be changed. Such a processing unit with changeable processing vessels is shown in FIG. 9.

A processing unit 3 with changeable processing vessels 5 comprises a vessel holder 99. The vessel holder 99 comprises a supply unit 101 with a closing element 103. The closing element 103 for example is in the form of a ball with an opening 105. For inserting the processing vessel into the vessel holder 99, the closing element 103 is in a first position, in which the opening 105 is arranged such that the processing vessel 5 can be pushed through the opening 105 into the vessel holder 99. To insert the processing vessel 5 into the vessel holder 99, for example a piston 107 can be used. In this case, the processing vessel 5 is placed on top of the piston 107 and for inserting the processing vessel 5 into the vessel holder 99, the piston 107 moves upwards an thus the processing vessel 5 also moves upwards through the opening 105 into the vessel holder 99. After having placed the processing vessel 5 in the vessel holder 99 the processing vessel 5 is arrested in this position to allow removing the piston 107 and to keep the processing vessel 5 in its position. This for example can be done by slightly twisting the closing element 103 so that an edge of the bottom of the processing vessel 5 stands on the closing element 103 at the edge of the opening 105. By this slight twisting the opening 105 remains in a position which allows moving the piston 107 downward to bring the piston 107 into a position in which the closing element 103 can be brought into a second position in which the processing vessel 5 is fixed in the vessel holder 99. In this second position, the opening 105 preferably is oriented perpendicularly to the central axis of the processing vessel 5, so that the processing vessel 5 rests on a surface of the closing element 103.

For carrying out the process in the processing vessel 5 at a defined temperature, it is preferred that the vessel holder 99 comprises the temperature control means 37 and that the vessel is not equipped with additional temperature control means.

The processing vessels 5 which are inserted into the vessel holder 99 can be delivered by using any delivery unit known to a skilled person. A suitable delivery unit for example may be a robot arm as shown in WO-A 2020/225110. Alternatively, the delivery unit also may comprise a carousel 109 as shown in FIG. 9. The processing vessels 5 are placed on a disc 111 of the carousel 109 and turned to a position where they can be lifted into the vessel holder 99 by the piston 107. For lifting the processing vessels 5, it is possible, to provide one piston below the disc 111 at the position where the vessel holder 99 is. In this case, the disc 111 has openings at the positions for the processing vessels 105 so that the piston can move through the openings, pick the processing vessel 5 and lift it into the holding device 99. As an alternative, it is also possible to equip the disc 111 with pistons 107 at each position for a processing vessel 5. In this case, the pistons rotate with the disc and for changing a processing vessel 5, the piston 107 which is at a position below the vessel holder 99 lifts the processing vessel 5 into the vessel holder 99.

FIG. 10 shows a unit for taking samples with a carousel changer. Like changing the processing vessels by using a carousel, it is also possible to use a carousel for the quenching bath 23 or any other container for collecting the pellets or test specimens or the viscous product.

The product which is withdrawn from the processing vessel 5 is fed into the flash tank 59. As an alternative to the flash tank 59, also the degassing vessel 67 which is shown as an example in FIG. 4 can be used.

From the flash tank 59, a gas stream is withdrawn via the first back pressure regulator 31 and may be transferred to measuring devices, for example devices for measuring the composition of the gas, pressure, temperature and amount.

The product is withdrawn from the flash tank 59 via the product outlet 13 and transferred via a first dosing unit 113, particularly a gear type pump, to a further degassing unit 115. Preferably, a sample is taken from the product before the product is fed into the degassing unit 115. The sample is transferred to suitable measuring devices 119. In these measuring devices 119, for example the amount, the composition and further data of the product can be determined.

The rest of the product which is fed into the degassing unit 115, passes the degassing unit 115 to a second dosing unit 117, which preferably also is a gear type pump running at a slightly faster rotation speed. However, particularly as an alternative for the second dosing unit also a screw injection machine may be used.

The product leaving the second dosing unit 117 is transferred into the quenching bath 23. If the maximum capacity of a quenching bath 23 is achieved or alternatively, if an experiment is finished and before a new one is started, the carousel 121 turns and a new quenching bath is placed below the outlet to receive the product.

List of reference numbers

| | |
|---|---|
| 1 | system |
| 3 | processing unit |
| 5 | processing vessel |
| 7 | feed line |
| 9 | second feed line |
| 11 | pump |
| 13 | product outlet |
| 15 | device for producing pellets or test specimens |
| 17 | dosing unit |
| 19 | outlet valve |
| 21 | flow restrictor |
| 23 | quenching bath |
| 25 | scales |
| 27 | gas outlet |
| 29 | pressure switch valve |
| 31 | first back pressure regulator |
| 33 | vacuum pump |
| 35 | second back pressure regulator |
| 37 | temperature control means |
| 39 | stirrer |
| 41 | cleaning unit |
| 43 | first outlet |
| 45 | separation unit for degassing |
| 47 | second outlet |
| 49 | waste container |
| 51 | outlet valve |
| 53 | reaction quench |
| 55 | mixer |
| 57 | third back pressure regulator |
| 59 | flash tank |
| 61 | tempering unit |
| 63 | screw injection machine |
| 65 | gas outlet |
| 67 | degassing vessel |
| 69 | stirrer |
| 71 | flow control |
| 73 | flow sensor |
| 75 | pressure indicator |
| 77 | temperature control |
| 79 | level measurement |
| 81 | unit for measuring the melt flow index |
| 83 | vessel |
| 85 | gas feed |
| 87 | pressure control |
| 89 | flow sensor |
| 91 | outlet valve |
| 93 | outlet |
| 95 | gas outlet |
| 97 | valve |
| 99 | vessel holder |
| 101 | supply unit |
| 103 | closing element |
| 105 | opening |
| 107 | piston |
| 109 | carousel |
| 111 | disc |
| 113 | first dosing unit |
| 115 | degassing unit |
| 117 | second dosing unit |
| 119 | measuring device |
| 121 | carousel |

1. A system for analyzing a large number of material systems in amounts in a range from 0.001 to 1 kg by which a product is achieved which has a viscosity of more than 10¹ mPas or which is solid at ambient conditions, the system comprising a processing unit for processing the viscous medium and at least one feeding device for feeding starting materials into the processing unit, the feeding device being established such that the amount of the starting material or the starting material can be varied, and the processing unit further comprises an outlet which is connected to a device for producing pellets or test specimens if the product is solid at ambient conditions or to a dosing pump for transferring the product into a collecting vessel if the product is highly viscous at ambient conditions.

2. The system according to claim 1, wherein a separation unit for degassing is arranged between the processing unit and the device for producing pellets or test specimens or the dosing pump for transferring the product into a collecting vessel.

3. The system according to claim 2, wherein the separation unit for degassing comprises a degassing vessel and a vacuum pump which is connected to the degassing vessel.

4. The system according to claim 1, wherein the device for producing pellets or test specimens comprises a dosing unit.

5. The system according to claim 1, wherein the dosing unit or the dosing pump is a gear type pump.

6. The system according to claim 4, wherein a mold for forming the pellets or the test specimens is connected to the dosing unit.

7. The system according to claim 4, wherein the dosing unit is a screw injection machine.

8. The system according to claim 7, wherein the screw injection machine is an extruder or an injection molding machine.

9. The system according to claim 1, wherein the processing unit comprises a processing vessel and the processing vessel and/or the degassing vessel comprise a stirrer.

10. The system according to claim 9, wherein the stirrer is a horseshoe mixer.

11. The system according to claim 10, wherein the horseshoe mixer comprises at least one stirrer blade which is designed such that solid material which deposits on the walls of the processing vessel and/or the degassing vessel is scraped off the walls by the stirrer blade.

12. The system according to claim 1, wherein the processing unit comprises a processing vessel and a vessel holder for changing the processing vessel.

13. The system according to claim 12, wherein the feeding device and the outlet are connected to the vessel holder.

14. The system according to claim 1, wherein the system comprises a cleaning unit for cleaning the processing unit.
